(19) United States
(12) Patent Application Publication
(10) Pub. No.: US 2009/0231723 A1
(43) Pub. Date: Sep. 17, 2009

(54) WIDE ANGLE PROJECTION LENS SYSTEM AND METHOD

(76) Inventors: Estill Thone Hall, Jr., Fishers, IN (US); JIngbo Cai, Vista, CA (US); Eugene Murphy O'Donnell, Fishers, IN (US)

Correspondence Address: FLETCHER YODER P.C., 7915 FM 1960 RD. WEST, SUITE 330, HOUSTON, TX, 77070, US

(21) Appl. No.: 12/294,594

(22) PCT Filed: Mar. 31, 2006
(86) PCT No.: PCT/US06/12146

§ 371 Date: Sep. 25, 2008

(51) Int. Cl. G02B 3/00; H04N 9/31

(52) U.S. Cl. 359/649; 348/744

(57) ABSTRACT

The disclosed embodiments relate to a system and method for wide angle image projection. An exemplary embodiment of the present invention comprises a video unit, comprising an imaging system configured to create a projected image, a lens group optically coupled to the imaging system to receive the projected image. The lens group including a lens doublet having a first positive crown element, a negative flint element affixed to the first positive crown element, and a second positive crown element adjacent to the lens doublet and facing the imaging system. The video unit further comprises a positive flint element optically coupled to the lens group to receive the projected image from the lens group, a physical stop disposed between the positive flint element and the lens group, and a negative crown meniscus optically coupled to the positive flint element to receive the projected image from the positive flint element, the negative crown meniscus adapted to produce a wide-angle representation of the projected image.

### CROSS-REFERENCE TO RELATED APPLICATIONS

This application is a National Phase 371 Application of PCT Application No. PCT/US06/12146, filed Mar. 31, 2006, entitled “Wide Angle Projection Lens System and Method”.

### FIELD OF THE INVENTION

The present invention relates generally to video display systems. More specifically, the present invention relates to an economical wide-angle projection system.

### BACKGROUND OF THE INVENTION

This section is intended to introduce the reader to various aspects of art, which may be related to various aspects of the present invention that are described and/or claimed below. This discussion is believed to be helpful in providing the reader with background information to facilitate a better understanding of the various aspects of the present invention. Accordingly, it should be understood that these statements are to be read in this light, and not as admissions of prior art.

As demand increases for large screen television sets (TVs), new technologies are emerging capable of delivering high performance systems at affordable costs. More importantly, as market pressures increase to reduce prices of such systems, companies have become more relentless in searching ways to improve their TV systems, while lowering their costs of manufacturing. Thus, companies are forced to market their product in an increasing competitive market without sacrificing product quality. This may be a challenging task, as today's TVs employ technologically sophisticated components whose composition and fabrication can significantly heighten the cost of the TV system. Particularly, such components may include imaging devices and image projection units.

Projection-based video units create video images by varying the color and shade of projected light. One example of a projection-based video unit is a digital light processing (“DLP”) system, which employs an optical semiconductor, known as a digital micro-mirror device (“DMD”) to create video images. Another example of a projection-based video unit is a liquid crystal display (“LCD”) projection system, which projects light through one or more LCD panels to create video images. Typically, projection-based video units, such as DLP and/or LCD, employ a projection lens system adapted to project an image onto a screen. Further, a wide-angle projection lens system embedded in large screen TVs comprises lens components and architecture thereof, essential for producing a desired projected imaged that is suitable for display on large screen TVs. Accordingly, fabrication of the lens components and amount thereof employed within the wide-angle projection lens system may significantly affect the overall performance and cost of a video display unit.

Hence, it is desirable to have wide-angle projection lens system capable of projecting high quality images on a screen, yet economical enough to be marketed competitively.

### SUMMARY OF THE INVENTION

Certain aspects commensurate in scope with the disclosed embodiments are set forth below. It should be understood that these aspects are presented merely to provide the reader with a brief summary of certain forms the invention might take and that these aspects are not intended to limit the scope of the invention. Indeed, the invention may encompass a variety of aspects that may not be set forth below.

Embodiments of the disclosed invention relate to a video unit, comprising an imaging system configured to create a projected image, a lens group optically coupled to the imaging system to receive the projected image. The lens group including: a lens doublet having a first positive crown element, a negative flint element affixed to the first positive crown element, and a second positive crown element adjacent to the lens doublet and facing the imaging system. The video unit further comprises a positive flint element optically coupled to the lens group to receive the projected image from the lens group, a physical stop disposed between the positive flint element and the lens group, and a negative crown meniscus optically coupled to the positive flint element to receive the projected image from the positive flint element, the negative crown meniscus adapted to produce a wide-angle representation of the projected image.

### BRIEF DESCRIPTION OF THE DRAWINGS

Advantages of the invention may become apparent upon reading the following detailed description and upon reference to the drawings in which:

FIG. 1 is a block diagram of a video unit in accordance with an exemplary embodiment of the present invention;

FIG. 2 is a diagram of a projection lens system in accordance with an exemplary embodiment of the present invention;

FIG. 3 is a diagram of a projection lens system in accordance with an exemplary embodiment of the present invention;

FIG. 4 is a diagram of a projection lens system in accordance with an exemplary embodiment of the present invention; and

FIG. 5 is a flow chart of a method in accordance with exemplary an embodiment of the present invention.

### DETAILED DESCRIPTION

One or more specific embodiments of the present invention will be described below. In an effort to provide a concise description of these embodiments, not all features of an actual implementation are described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

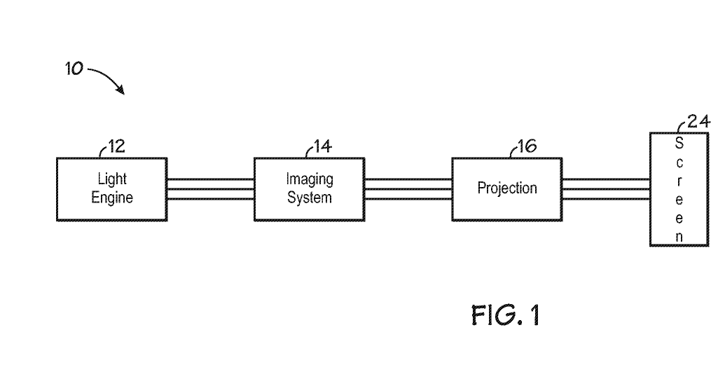

Turning initially to FIG. 1, a block diagram of a video unit in accordance with one embodiment of the present invention is illustrated and generally designated by a reference numeral 10. In the illustrated embodiment, the video unit 10 may comprise a Digital Light Processing (“DLP”) projection television or projector or the like. In another embodiment, the video unit 10 may comprise a liquid crystal display (“LCD”) projection television or projector or the like. In still other embodiments, the video unit 10 may comprise another suitable form of projection television or display.

The video unit 10 includes a light engine 12. The light engine 12 is configured to generate white or colored light that can be employed by an imaging system 14 to create a video image. The light engine 12 may include any suitable form of lamp or bulb capable of projecting white or generally white light. In one embodiment, the light engine 12 may be a high intensity light source, such as a metal halide lamp or a mercury vapor lamp. For example, the light engine 12 may include an ultra high performance (“UHP”) lamp produced by Philips Electronics. The light engine 12 may also include a component configured to convert the projected white light into colored light, such as color wheels, dichroic mirrors, polarizers, and filters. Moreover, in alternate embodiments, the light engine 12 may include components capable of generating color light, such as light emitting diodes.

As described above, the light engine 12 may be configured to project, shine, or focus colored light at the imaging system 14. The imaging system 14 may be configured to employ the colored light to create images suitable for display on a screen 24. The imaging system 14 may be configured to generate one or more pixel patterns that can be used to calibrate pixel shifting in the video unit 10. In one embodiment, the imaging system 14 comprises a DLP imaging system that employs one or more DMDs to generate a video image using the colored light. In another embodiment, the imaging system may employ an LCD projection system. It will be appreciated, however, that the above-described exemplary embodiments are not intended to be exclusive, and that alternate embodiments, any suitable form of imaging system 14 may be employed in the video unit 10.

The imaging system 14 illustrated in FIG. 1 may be configured to project images into a wide-angle projection lens assembly 16. As described further below, the wide-angle projection lens assembly 16 may include one or more lenses and/or mirrors that project the image created by the imaging system 14 onto the screen 24. As used herein, the term “wide-angle” means an angle of image projection suitable for a wide screen T.V.

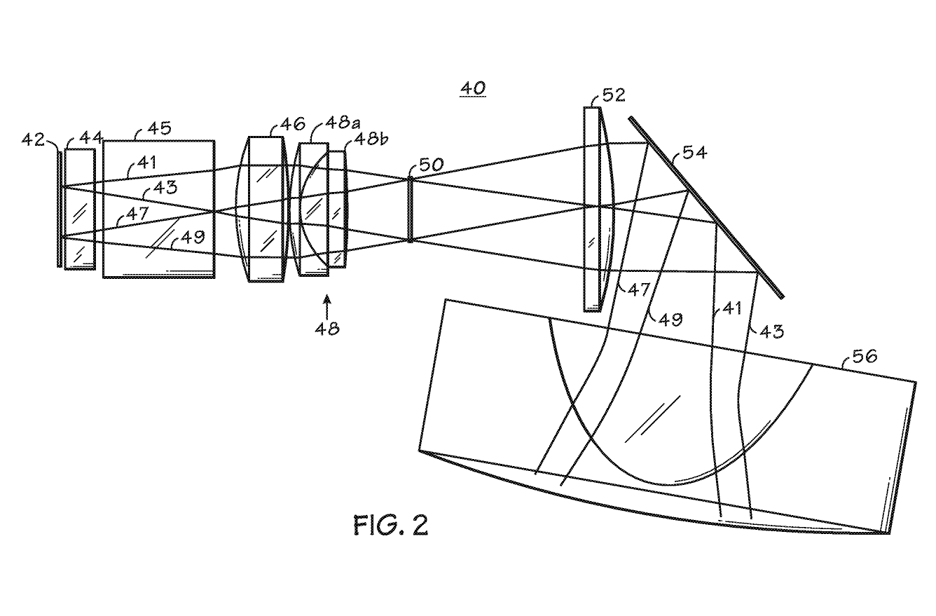

FIG. 2 is a diagram of a projection lens system in accordance with an exemplary embodiment of the present invention, generally designated by reference numeral 40. The lens system 40 is adapted to produce a wide-angle projection or representation of an image. The system 40 projects the image, so that it may be formed and viewed on the display device 24, such as a wide screen TV. The system 40 comprises an imaging device 42, such as a DMD, with a cover glass 44. As described below, the DMD 42 is disposed adjacent to additional lens elements. The DMD 42 generates light components that are projected onto lens elements adapted to produce a wide angle projection of an image. In this exemplary embodiment, the DMD 42 provides a plane from which exemplary chief light rays 41, 43, 47, and 49 originate in the lens assembly 40. Although, only four exemplary light rays are shown in FIG. 2 for purposes of illustration, it should be appreciated by those skilled in the art that in actuality a bundle of light rays emanates from the imaging device 42.

The system 40 further includes a total internal reflection (TIR) prism 45, disposed adjacent to the cover glass 44. Colored light components comprising red, green, and blue (RGB) are emitted by the DMD 42 and projected through the TIR prism 45. In addition to the colored light components, image illumination light components (not shown) are also entering the TIR prism 45 enroute to the DMD 42 as well. The purpose of the TIR prism 45 is to direct these two different light bundles to their respective destinations. That is the illumination light is directed to the DMD 42 and the colored light components are directed into the first lens element 46. Accordingly, the TIR 45 is adapted to separate image RGB and illumination components.

Next, the image is projected onto a lens group disposed adjacent to the TIR prism 45, as depicted by exemplary light rays 41, 43, 47 and 49. The lens group includes a positive crown element 46 and a positive doublet lens 48. In an exemplary embodiment, the positive doublet lens 48 is further comprised of a positive crown element 48a affixed to a negative flint element 48b. These later crown and flint elements may be cemented, attached, and/or disposed adjacent to one another. The positive crown element 46 is adapted to converge the light exiting the TIR prism 45. Such convergence is employed, so that the light is maintained on a path permitting its subsequent projection and processing by additional optical elements comprising the projection lens system 40. The positive crown element 46 effectively functions as a “formatting” lens, which preconditions the light for subsequent processing.

The positive doublet lens 48 is utilized for color correcting the light exiting the positive crown element 46. The RGB light components exiting the DMD 42 are comprised of various electromagnetic wavelengths. Accordingly, each wavelength of the light refracts at a different angle, as it propagates through the positive crown element 46 and projected therefrom onto the doublet lens 48. Hence, the doublet lens 48 assures images formed by the different colored-light components are focused appropriately.

The positive crown element 46 and the affixed positive crown element 48a are disposed relative to one another, such that a double concave lens-shaped air gap is formed there between. The surface of the element 48a and the later concave shaped air gap are adapted to correct higher order aberrations occurring at full aperture and large field of view. Achieving a deeply concave affixed surface, such as the affixed surface of the element 48a, and the air gap disposed therefrom may need greater fabricating and assembling tolerances. However, affixing optical elements 48a to 48b, as well as vertex-contacting element 46 with the doublet 48 eases the fabrication process of the system 40.

Light projected from the doublet 48 further propagates through physical stop 50. The physical stop 50 is disposed, in the center of gravity of the optical path formed by the light traversing throughout the system 40. This means that the physical stop 50 is optically disposed halfway between the DMD 42 and an exit point from where the light emerges out the projection system 40. Subsequent to the physical stop 50, a dense flint glass element 52 of positive power is disposed at some distance from the physical stop 50. The flint glass element 52 further attenuates the angles of the light rays exiting the physical stop 50. This attenuation causes the light to not overshoot a folding mirror 54. Effectively, flint glass element 52 is configured to prevent overshoot by prolonging the optical path of the light propagating from the physical stop 50 and the mirror 54, thus ensuring it is properly projected thereon.

The folding mirror 54 is disposed at an angle relative to the horizontal path of the chief rays 41, 43, 47, and 49 that emerge from the positive flint element 52. Accordingly, the mirror 54 reflects the rays 41, 43, 47, 49 folding, and thus, deviating the light from its horizontal direction. Absent the mirror 54, light rays emerging from lens 54 would continue to propagate along a horizontal path, extending the length of the lens system 40. Employing the mirror 54, the length of the lens assembly 40 is shortened, rendering it more compact. The mirror 54 may be further adapted to wiggle synchronously with the micro mechanical mirrors of the imaging device, such as the ones employed in the DMD 42. The synchronous wiggling between the mirror 52 and the micro-mirrors of the display device optimizes the projection of an image generated by the DMD 42.

Light reflected from mirror 54 is projected onto a crown plastic meniscus element 56 of negative power. In an exemplary embodiment, the meniscus element 56 is comprised of acrylic having two eighth-order aspheric surfaces. Thus, the meniscus element 56 is configured to increase the back focal length, widen the field of view, and flatten the image produced by the system 40. Accordingly, conic constants and aspheric coefficients of front and back surfaces of the meniscus element 56 minimize distortion and astigmatism.

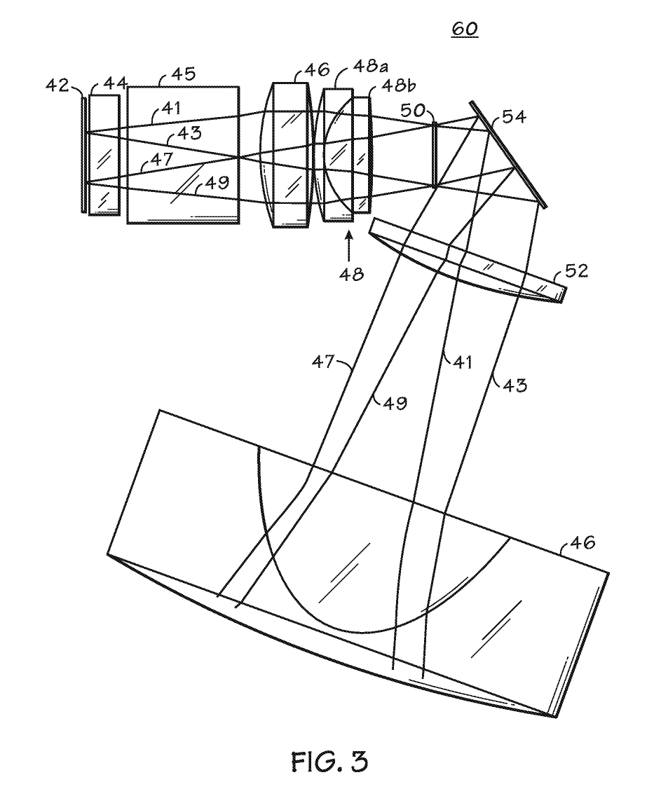

FIG. 3 is a diagram of a projection lens system in accordance with an exemplary embodiment of the present invention, generally designated by reference numeral 60. The system 60 is similar in composition and structure to the system 40 shown in FIG. 2. However, in the lens projection system 60 the positive flint glass element 52 is disposed between the folding mirror 54 and the meniscus element 56. Such a configuration has the advantage of shortening the length of the projection system, with minimally increased height. It should be appreciated that although system 60 may be similar in composition and structure to the system 40, the spatial arrangement of the optical elements given by the system 60 may require unique fabrication and positioning specifications of all the optical and other elements comprising the system 60, as will be appreciated by one of ordinary skill in the art.

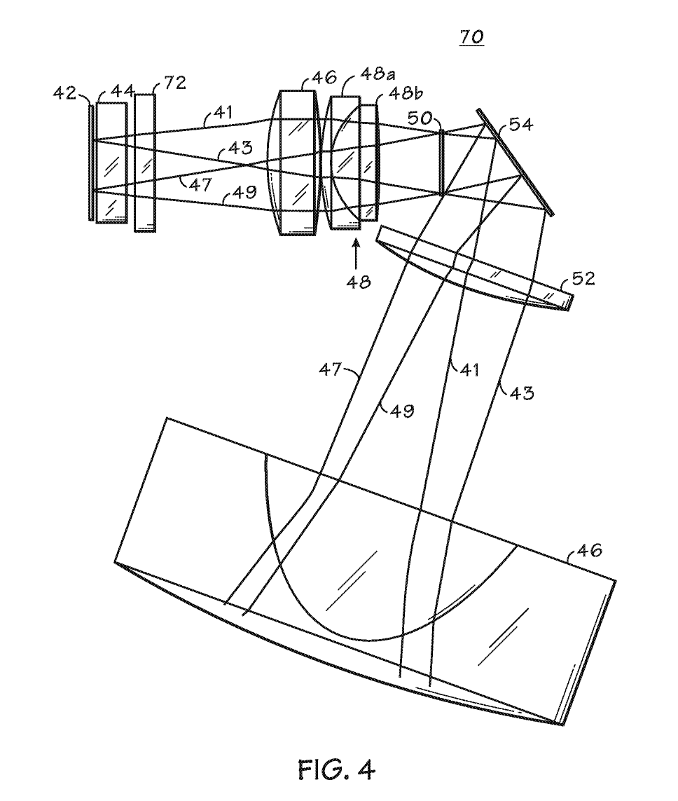

FIG. 4 is a diagram of a projection lens system in accordance with an exemplary embodiment of the present invention, generally referred to by reference numeral 70. The lens system 70 is similar both in structure and in composition to the lens system 60 shown in FIG. 3. However, in the system 70, the TIR prism 45 (FIG. 3) is replaced with a field lens 72. The field lens 72 effectively functions like the TIR prism 45, while providing a better illumination. By employing the field lens 72, the system 70 is more efficient in producing a brighter image on a display device. It should be appreciated that replacing the TIR prism 45 with the field lens 72 in the system 70 may require unique fabrication and positioning specifications of all optical and other elements comprising the system 70, as will be appreciated by one of ordinary skill in the art.

In an exemplary embodiment, the projection lens systems 40, 60 and 70 all have the positive lens group, comprising the lens elements 46 and 48, as well the positive flint element 52. In the systems 40, 60, and 70, the positive lens group and the positive flint element are arraigned somewhat symmetrically about the physical stop 50. As previously mentioned, exemplary embodiments of the systems 40, 60, and 70 also have an acrylic-made meniscus element 56 of negative power coupled to flint element 52. The above unique configuration is advantageous in wide-angle projection because it achieves a large field of view, a large back focal length, and good aberration correction. Further, the arrangement of positive powers on both sides of a physical stop accommodates an easier large aperture requirement, and it provides a better control on lateral aberrations. The use of an acrylic-made meniscus element, such as element 56, and the reduced number of optical elements employed in each of the systems 40, 60 and 70 renders these systems highly performing, yet economical.

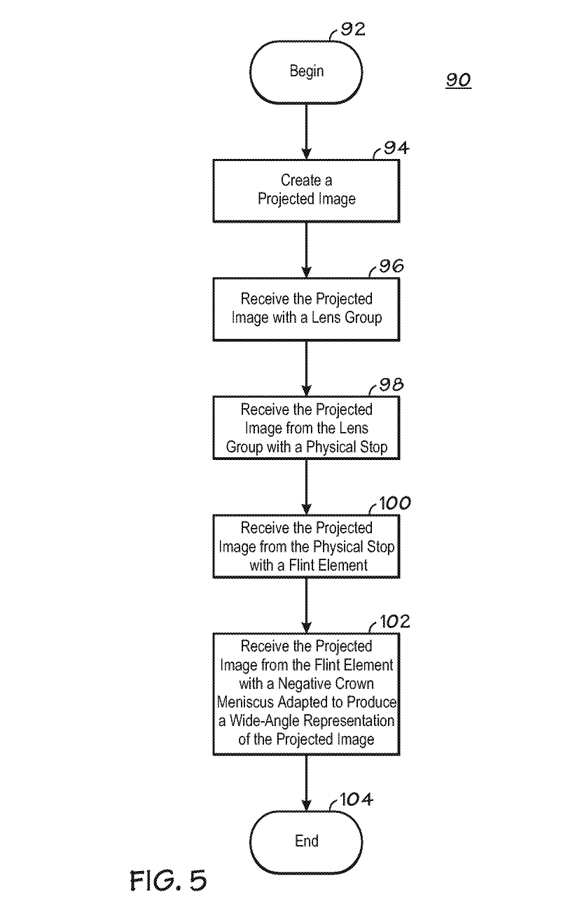

FIG. 5 is a flow chart of a method in accordance with exemplary an embodiment of the present invention, generally designated by reference numeral 90. The flow chart 90 shows a method for wide-angle projection of an image. The method begins at block 92. At block 94 an image is generate and projected an imaging device. At block 96, the projected image is received using a lens group. Thereafter, at block 98 the projected image is received from the lens group with a physical stop 50. At block 100 the projected image is received from the physical stop 50 with a flint element 52. At block 102 the projected image is received from the flint element 52 with a negative crown meniscus 56 that is adapted to produce a wide-angle representation of the projected image. Lastly, the method ends at block 104.

An example of computer code useful for designing an exemplary embodiment of the present invention is given below:

### General Lens Data:

| Surfaces | 15 | |
|---|---|---|
| Stop | 5 | |
| System Aperture | Float By Stop Size = 2.97427 | |
| Glass Catalogs | SCHOTT SUMITA MISC CORNING | |
| | SCHOTT_2000 | |
| Ray Aiming | Paraxial Reference, Cache On | |
| X Pupil shift | 2 | |
| Y Pupil shift | 2 | |
| Z Pupil shift | 2 | |
| Apodization | Uniform, factor = 0.00000E+000 | |
| Effective Focal Length | 5.24246 | (in air at system temperature and |
| | | pressure) |
| Effective Focal Length | 5.24246 | (in image space) |

| | |
|---|---|
| Back Focal Length | 0.5231015 |
| Total Track | 94.93611 |
| Image Space F/# | 2.639217 |
| Paraxial Working F/# | 2.6414 |
| Working F/# | 2.65 |
| Image Space NA | 0.1859907 |
| Object Space NA | 0.001613689 |
| Stop Radius | 2.974271 |
| Paraxial Image Height | 5.629782 |
| Paraxial Magnification | −0.008524808 |
| Entrance Pupil Diameter | 1.986369 |
| Entrance Pupil Position | 15.47372 |
| Exit Pupil Diameter | 20.4766 |
| Exit Pupil Position | −54.00208 |
| Field Type | Object height in Millimeters |
| Maximum Field | 660.3998 |
| Primary Wave | 0.5875618 |
| Lens Units | Millimeters |
| Angular Magnification | 0.09700564 |
| Fields | 6 |

### Field Type: Object Height in Millimeters

| # | X-Value | Y-Value | Weight |
|---|---|---|---|
| 1 | 0.000000 | 0.000000 | 1.000000 |
| 2 | 0.000000 | 323.769000 | 1.000000 |
| 3 | 287.794000 | 161.884000 | 1.000000 |
| 4 | −489.249800 | −275.204000 | 1.000000 |
| 5 | 575.588000 | 0.000000 | 1.000000 |
| 6 | 575.588000 | 323.769000 | 1.000000 |

Wavelengths: 3
Units: Microns

| # | Value | Weight |
|---|---|---|
| 1 | 0.486133 | 1.000000 |
| 2 | 0.587562 | 1.000000 |
| 3 | 0.656273 | 1.000000 |

### Surface Data Summary:

| Surf | Type | Radius | Thickness | Glass | Diameter | Conic |
|---|---|---|---|---|---|---|
| OBJ | STANDARD | Infinity | 600 | | 1320.8 | 0 |
| 1 | EVENASPH | 355.8713 | 3 | ACRYLIC | 47.46676 | 97.42966 |
| 2 | EVENASPH | 7.968193 | 36.78204 | | 26.74832 | −1.049251 |
| 3 | STANDARD | 39.22639 | 3 | N-SF56 | 20.17972 | 0 |
| 4 | STANDARD | −314.5877 | 17.28227 | | 19.59733 | 0 |
| STO | STANDARD | Infinity | 6.282983 | | 5.948542 | 0 |
| 6 | STANDARD | 74.43345 | 4.782975 | CSK12 | 10.74056 | 0 |
| 7 | STANDARD | −7.244735 | 0.9999907 | D85-25 | 11.43767 | 0 |
| 8 | STANDARD | −19.49721 | 0 | | 12.99901 | 0 |
| 9 | STANDARD | 36.12245 | 5.324974 | SK5 | 13.87081 | 0 |
| 10 | STANDARD | −19.89504 | 2.146881 | | 14.36298 | 0 |
| 11 | STANDARD | Infinity | 11 | BK7 | 13.59083 | 0 |
| 12 | STANDARD | Infinity | 0.851 | | 12.00212 | 0 |
| 13 | STANDARD | Infinity | 3 | A87-70 | 11.81493 | 0 |
| 14 | STANDARD | Infinity | 0.483 | | 11.37411 | 0 |
| IMA | STANDARD | Infinity | | | 11.26787 | 0 |

### Surface Data Detail:

| | | | |
|---|---|---|---|
| Surface | OBJ | | STANDARD |
| Surface | 1 | | EVENASPH |
| Coeff on | r | 2 | 0 |
| Coeff on | r | 4 | 1.1062054e−005 |
| Coeff on | r | 6 | −1.7594351e−008 |
| Coeff on | r | 8 | 9.1390405e−012 |
| Coeff on | r | 10 | 0 |
| Coeff on | r | 12 | 0 |
| Coeff on | r | 14 | 0 |
| Coeff on | r | 16 | 0 |
| Surface | 2 | | EVENASPH |
| Coeff on | r | 2 | 0 |
| Coeff on | r | 4 | 5.2743008e−005 |
| Coeff on | r | 6 | 4.7336555e−007 |
| Coeff on | r | 8 | −7.1379292e−010 |
| Coeff on | r | 10 | 0 |
| Coeff on | r | 12 | 0 |
| Coeff on | r | 14 | 0 |
| Coeff on | r | 16 | 0 |
| Surface | 3 | | STANDARD |
| Surface | 4 | | STANDARD |
| Surface | STO | | STANDARD |
| Surface | 6 | | STANDARD |
| Surface | 7 | | STANDARD |
| Surface | 8 | | STANDARD |
| Surface | 9 | | STANDARD |
| Surface | 10 | | STANDARD |
| Surface | 11 | | STANDARD |
| Surface | 12 | | STANDARD |
| Surface | 13 | | STANDARD |
| Surface | 14 | | STANDARD |
| Surface | IMA | | STANDARD. |

A further example of computer code useful for designing an exemplary embodiment of the present invention is given below:

### General Lens Data:

| Surfaces | 15 | |
|---|---|---|
| Stop | 5 | |
| System Aperture | Image Space F/# = 2.65 | |
| Glass Catalogs | Schott Sumita misc corning | |
| Ray Aiming | Paraxial Reference, Cache On | |
| X Pupil shift | 2 | |
| Y Pupil shift | 2 | |
| Z Pupil shift | 2 | |
| Apodization | Uniform, factor = 0.00000E+000 | |
| Effective Focal Length | 5.248778 | (in air at system temperature |
| | | and pressure) |
| Effective Focal Length | 5.248778 | (in image space) |

| | |
|---|---|
| Back Focal Length | 0.4391037 |
| Total Track | 109.3255 |
| Image Space F/# | 2.65 |
| Paraxial Working F/# | 2.651058 |
| Working F/# | 2.665182 |
| Image Space NA | 0.1853364 |
| Object Space NA | 0.001604225 |
| Stop Radius | 3.201898 |
| Paraxial Image Height | 5.617229 |
| Paraxial Magnification | −0.0085058 |
| Entrance Pupil Diameter | 1.980671 |
| Entrance Pupil Position | 17.32871 |
| Exit Pupil Diameter | 42.1831 |
| Exit Pupil Position | −111.8299 |
| Field Type | Object height in Millimeters |
| Maximum Field | 660.3998 |
| Primary Wave | 0.5875618 |
| Lens Units | Millimeters |
| Angular Magnification | 0.04695296 |
| Fields | 6 |

Field Type: Object height in Millimeters

| # | X-Value | Y-Value | Weight |
|---|---|---|---|
| 1 | 0.000000 | 0.000000 | 1.000000 |
| 2 | 0.000000 | 323.769000 | 1.000000 |
| 3 | 287.794000 | 161.884000 | 1.000000 |
| 4 | −489.249800 | −275.204000 | 1.000000 |
| 5 | 575.588000 | 0.000000 | 1.000000 |
| 6 | 575.588000 | 323.769000 | 1.000000 |

Wavelengths: 3
Units: Microns

| # | Value | Weight |
|---|---|---|
| 1 | 0.486133 | 1.000000 |
| 2 | 0.587562 | 1.000000 |
| 3 | 0.656273 | 1.000000 |

### Surface Data Summary:

| Surf | Type | Radius | Thickness | Glass | Diameter | Conic |
|---|---|---|---|---|---|---|
| OBJ | STANDARD | Infinity | 600 | | 1320.8 | 0 |
| 1 | EVENASPH | 56.32781 | 3 | ACRYLIC | 51.96127 | −61.97635 |
| 2 | EVENASPH | 7.717042 | 40.03644 | | 28.90669 | −0.9835658 |
| 3 | STANDARD | 181.0375 | 5 | SFLD20 | 22.64673 | 0 |
| 4 | STANDARD | −65.77548 | 21.31247 | | 21.90694 | 0 |
| STO | STANDARD | Infinity | 10.10311 | | 6.403796 | 0 |
| 6 | STANDARD | 54.38987 | 4.782975 | SK5 | 13.92528 | 0 |
| 7 | STANDARD | −9.597402 | 0.9999907 | SFLDN3 | 14.29757 | 0 |
| 8 | STANDARD | −22.50471 | 0 | | 15.80909 | 0 |
| 9 | STANDARD | 25.45693 | 5.324974 | SK5 | 16.91734 | 0 |
| 10 | STANDARD | −33.07775 | 3.430812 | | 16.83337 | 0 |
| 11 | STANDARD | Infinity | 11 | BK7 | 15.15583 | 0 |
| 12 | STANDARD | Infinity | 0.851 | | 12.50787 | 0 |
| 13 | STANDARD | Infinity | 3 | A87-70 | 12.19309 | 0 |
| 14 | STANDARD | Infinity | 0.4837488 | | 11.45625 | 0 |
| IMA | STANDARD | Infinity | | | 11.27731 | 0 |

### Surface Data Detail:

| | | | |
|---|---|---|---|
| Surface | OBJ | | STANDARD |
| Surface | 1 | | EVENASPH |
| Coeff on | r | 2 | 0 |
| Coeff on | r | 4 | 7.1599218e−006 |
| Coeff on | r | 6 | −8.062123e−009 |
| Coeff on | r | 8 | 3.2239437e−012 |
| Coeff on | r | 10 | 0 |
| Coeff on | r | 12 | 0 |
| Coeff on | r | 14 | 0 |
| Coeff on | r | 16 | 0 |
| Surface | 2 | | EVENASPH |
| Coeff on | r | 2 | 0 |
| Coeff on | r | 4 | 3.0289934e−005 |
| Coeff on | r | 6 | 2.169739e−007 |
| Coeff on | r | 8 | 1.1775346e−010 |
| Coeff on | r | 10 | 0 |
| Coeff on | r | 12 | 0 |
| Coeff on | r | 14 | 0 |
| Coeff on | r | 16 | 0 |
| Surface | 3 | | STANDARD |
| Surface | 4 | | STANDARD |
| Surface | STO | | STANDARD |
| Surface | 6 | | STANDARD |
| Surface | 7 | | STANDARD |
| Surface | 8 | | STANDARD |
| Surface | 9 | | STANDARD |
| Surface | 10 | | STANDARD |
| Surface | 11 | | STANDARD |
| Surface | 12 | | STANDARD |
| Surface | 13 | | STANDARD |
| Surface | 14 | | STANDARD |
| Surface | IMA | | STANDARD. |

Yet another example of computer code useful for designing an exemplary embodiment of the present invention is given below:

### General Lens Data:

| Surfaces | 15 | |
|---|---|---|
| Stop | 5 | |
| System Aperture | Image Space F/# = 2.65 | |
| Glass Catalogs | Schott Sumita misc corning | |
| Ray Aiming | Paraxial Reference, Cache On | |
| X Pupil shift | 2 | |
| Y Pupil shift | 2 | |
| Z Pupil shift | 2 | |
| Apodization | Uniform, factor = 0.00000E+000 | |
| Effective Focal Length | 5.236171 | (in air at system temperature |
| | | and pressure) |
| Effective Focal Length | 5.236171 | (in image space) |

| | |
|---|---|
| Back Focal Length | 0.4402165 |
| Total Track | 96.07866 |
| Image Space F/# | 2.65 |
| Paraxial Working F/# | 2.650864 |
| Working F/# | 2.668295 |
| Image Space NA | 0.1853495 |
| Object Space NA | 0.001604343 |
| Stop Radius | 3.212782 |
| Paraxial Image Height | 5.617229 |
| Paraxial Magnification | −0.008505801 |
| Entrance Pupil Diameter | 1.975913 |
| Entrance Pupil Position | 15.8006 |
| Exit Pupil Diameter | 51.5662 |
| Exit Pupil Position | −136.695 |
| Field Type | Object height in Millimeters |
| Maximum Field | 660.3998 |
| Primary Wave | 0.5875618 |
| Lens Units | Millimeters |
| Angular Magnification | 0.03831682 |
| Fields | 6 |

Field Type: Object height in Millimeters

| # | X-Value | Y-Value | Weight |
|---|---|---|---|
| 1 | 0.000000 | 0.000000 | 1.000000 |
| 2 | 0.000000 | 323.769000 | 1.000000 |
| 3 | 287.794000 | 161.884000 | 1.000000 |
| 4 | −489.249800 | −275.204000 | 1.000000 |
| 5 | 575.588000 | 0.000000 | 1.000000 |
| 6 | 575.588000 | 323.769000 | 1.000000 |

Wavelengths: 3
Units: Microns

| # | Value | Weight |
|---|---|---|
| 1 | 0.486133 | 1.000000 |
| 2 | 0.587562 | 1.000000 |
| 3 | 0.656273 | 1.000000 |

### Surface Data Summary:

| Surf | Type | Radius | Thickness | Glass | Diameter | Conic |
|---|---|---|---|---|---|---|
| OBJ | STANDARD | Infinity | 600 | | 1320.8 | 0 |
| 1 | EVENASPH | 42.52054 | 3 | ACRYLIC | 46.32803 | 1.383767 |
| 2 | EVENASPH | 6.826374 | 40.00575 | | 24.99873 | −1.56571 |
| 3 | STANDARD | 69.24866 | 5.502282 | SFLD66 | 17.03269 | 0 |
| 4 | STANDARD | −86.92522 | 12.85154 | | 15.69634 | 0 |
| STO | STANDARD | Infinity | 7.602353 | | 6.425564 | 0 |
| 6 | STANDARD | 46.21191 | 4.782975 | SK5 | 11.87228 | 0 |
| 7 | STANDARD | −8.823901 | 0.9999907 | SFL57 | 12.43972 | 0 |
| 8 | STANDARD | −24.91574 | 0 | | 13.7616 | 0 |
| 9 | STANDARD | 34.07092 | 5.324974 | SK5 | 14.56086 | 0 |
| 10 | STANDARD | −24.70391 | 9.973043 | | 14.94001 | 0 |
| 11 | STANDARD | 89 | 1.7 | KZFSN5 | 12.71349 | 0 |
| 12 | STANDARD | −130 | 0.851 | | 12.48532 | 0 |
| 13 | STANDARD | Infinity | 3 | A87-70 | 12.12825 | 0 |
| 14 | STANDARD | Infinity | 0.4847544 | | 11.41719 | 0 |
| IMA | STANDARD | Infinity | | | 11.24931 | 0 |

### Surface Data Detail:

| | | | |
|---|---|---|---|
| Surface | OBJ | | STANDARD |
| Surface | 1 | | EVENASPH |
| Coeff on | r | 2 | 0 |
| Coeff on | r | 4 | −1.6457662e−005 |
| Coeff on | r | 6 | 2.2892123e−008 |
| Coeff on | r | 8 | −2.597088e−011 |
| Coeff on | r | 10 | 0 |
| Coeff on | r | 12 | 0 |
| Coeff on | r | 14 | 0 |
| Coeff on | r | 16 | 0 |
| Surface | 2 | | EVENASPH |
| Coeff on | r | 2 | 0 |
| Coeff on | r | 4 | 0.00034215973 |
| Coeff on | r | 6 | −1.1792122e−006 |
| Coeff on | r | 8 | 5.8144252e−009 |
| Coeff on | r | 10 | 0 |
| Coeff on | r | 12 | 0 |
| Coeff on | r | 14 | 0 |
| Coeff on | r | 16 | 0 |
| Surface | 3 | | STANDARD |
| Surface | 4 | | STANDARD |
| Surface | STO | | STANDARD |
| Surface | 6 | | STANDARD |
| Surface | 7 | | STANDARD |
| Surface | 8 | | STANDARD |
| Surface | 9 | | STANDARD |
| Surface | 10 | | STANDARD |
| Surface | 11 | | STANDARD |
| Surface | 12 | | STANDARD |
| Surface | 13 | | STANDARD |
| Surface | 14 | | STANDARD |
| Surface | IMA | | STANDARD |

While the invention may be susceptible to various modifications and alternative forms, specific embodiments have been shown by way of example in the drawings and will be described in detail herein. However, it should be understood that the invention is not intended to be limited to the particular forms disclosed. Rather, the invention is to cover all modifications, equivalents and alternatives falling within the spirit and scope of the invention as defined by the following appended claims.

What is claimed is:

1. A video unit, comprising:
an imaging system configured to create a projected image;
a lens group optically coupled to the imaging system to receive the projected image, the lens group including:
a lens doublet having a first positive crown element;
a negative flint element affixed to the first positive crown element; and
a second positive crown element adjacent to the lens doublet and facing the imaging system;
a positive flint element optically coupled to the lens group to receive the projected image from the lens group;
a physical stop disposed between the positive flint element and the lens group; and
a negative crown meniscus optically coupled to the positive flint element to receive the projected image from the positive flint element, the negative crown meniscus adapted to produce a wide-angle representation of the projected image.

2. The video unit recited in claim 1, wherein the negative crown meniscus comprises of acrylic.

3. The video unit recited in claim 1, comprising a mirror configured to fold the projected image.

4. The video unit recited in claim 3, wherein the mirror is configured to wiggle in accordance with a digital micro device of the imaging system.

5. The video unit recited in claim 1, comprising a total internal reflection (TIR) prism configured to project the image.

6. The video unit recited in claim 1, comprising a field lens configured to project the image.

7. The video unit recited in claim 1, wherein the physical stop is optically disposed halfway between the imaging system and the negative crown meniscus.

8. The video unit recited in claim 1, comprising a folding mirror disposed between and the negative crown meniscus and the positive flint element.

9. The video unit recited in claim 8, wherein the positive flint element is disposed between the folding mirror and the negative crown meniscus.

10. The video unit recited in claim 1, wherein the negative crown meniscus is adapted to have two-eight order aspheric surfaces.

11. A method, comprising;
creating a projected image;
receiving the projected image with a lens group comprising a lens doublet having a first positive crown element, a negative flint element affixed to the first positive crown element, and a second positive crown element adjacent to the lens doublet and facing the imaging system;
receiving the projected image from the lens group with a physical stop 50;
receiving the projected image from the physical stop with a flint element; and
receiving the projected image from the flint element with a negative crown meniscus that is adapted to produce a wide-angle representation of the projected image.

12. The method recited in claim 11, comprising optically disposing the physical stop halfway between the imaging system and the negative crown meniscus.

13. The method recited in claim 11, comprising disposing a folding mirror between the negative crown meniscus and the positive flint element.

14. The method recited in claim 13, wherein the positive flint element disposed between the folding mirror and the negative crown meniscus.

15. The video unit recited in claim 11, wherein the negative crown meniscus has two-eight order aspheric surfaces.

16. The method recited in claim 11 comprising projecting the image using a total internal reflection (TIR) prism.

17. The method recited in claim 11, comprising projecting the image using a field lens.

18. The method recited in claim 11, comprising folding the projected image.

19. The method recited in claim 11, comprising configuring the mirror to wiggle in accordance with a digital micro device of the imaging system.

20. A television (TV) system, comprising:
an imaging system configured to create a projected image;
a projection system comprising: a lens group optically coupled to the imaging system to receive the projected image, the lens group including:
a lens doublet having a first positive crown element;
a negative flint element affixed to the first positive crown element; and
a second positive crown element adjacent to the lens doublet and facing the imaging system;
a positive flint element optically coupled to the lens group to receive the projected image from the lens group;
a physical stop disposed between the positive flint element and the lens group;
a negative crown meniscus optically coupled to the positive flint element to receive the projected image from the positive flint element, the negative crown meniscus adapted to produce a wide-angle representation of the projected image; and
a display device configured to display the wide-angle representation of the image.
